(19) United States
(12) Patent Application Publication
(10) Pub. No.: US 2026/0369155 A1
(43) Pub. Date: Nov. 19, 2026

(54) Systems, Methods and Devices for Implementing an Alerting Platform

(71) Applicant: MIDL Technology Inc., Tuckahoe, NY (US)

(72) Inventors: Gabe AJRAM, Scarsdale, NY (US); Owen NASHELSKY, Rye, NY (US)

(21) Appl. No.: 19/678,103

(22) Filed: May 14, 2026

Related U.S. Application Data
(60) Provisional application No. 63/805,670, filed on May 14, 2025.

(51) Int. Cl. G08B 25/00

(52) U.S. Cl. CPC G08B 25/006

(57) ABSTRACT

A system having a processor coupled to memory, the processor configured to receive multiple inputs associated with an alert, wherein a first one of the multiple inputs has a different format from a second one of the multiple inputs, normalize the first one and the second one of the multiple inputs into a common data representation, determine, based on the multiple inputs, whether a trigger condition for the alert has been satisfied and when the trigger condition has been satisfied, generate an alert response.

### PRIORITY/INCORPORATION BY REFERENCE

This application claims priority to U.S. Provisional Application Serial No. 63/805,670 filed on May 14, 2025, and entitled “Alerting Engine,” the entirety of which is incorporated by reference herein.

### BACKGROUND

Traditional alerting systems often rely on rigid, single-state Finite State Machines (FSMs) that lack the flexibility to effectively handle the complex and dynamic nature of modern security environments. In the rapidly evolving landscape of security systems and Internet of Things (IoT) technologies, there exists a critical need for a unified and adaptive alerting engine capable of seamlessly integrating data from diverse sources such as physical security, IoT devices, and cyber-security systems.

### SUMMARY

Some example embodiments are related to a system having a processor coupled to memory, the processor configured to receive multiple inputs associated with an alert, wherein a first one of the multiple inputs has a different format from a second one of the multiple inputs, normalize the first one and the second one of the multiple inputs into a common data representation, determine, based on the multiple inputs, whether a trigger condition for the alert has been satisfied and when the trigger condition has been satisfied, generate an alert response.

Other example embodiments are related to a method for receiving multiple inputs associated with an alert, wherein a first one of the multiple inputs has a different format from a second one of the multiple inputs, normalizing the first one and the second one of the multiple inputs into a common data representation, determining, based on the multiple inputs, whether a trigger condition for the alert has been satisfied and when the trigger condition has been satisfied, generating an alert response.

### BRIEF DESCRIPTION OF THE DRAWINGS

FIG. 1 shows an example architecture according to various example embodiments.

FIG. 2 shows an example method for contrastive language image pre-training (CLIP) according to various example embodiments.

FIG. 3 shows an example method for formatting alerts according to various example embodiments.

FIG. 4 shows an example graphic user interface (GUI) for formatting alerts according to various example embodiments.

FIG. 5 shows an example method for generating alerts according to various example embodiments.

FIG. 6 shows an example of an image output for an object search according to various example embodiments.

FIG. 7 shows an example of refining an image search according to various example embodiments.

FIG. 8 shows an illustrative implementation of a computer system that may be used in connection with any of the embodiments of the disclosure provided herein.

### DETAILED DESCRIPTION

The example embodiments may be further understood with reference to the following description and the related appended drawings, wherein like elements are provided with the same reference numerals. The example embodiments relate to an alert platform that allows for alerts to be formatted and generated. The alert platform comprises a configurable alerting and rule evaluation platform capable of ingesting data from multiple, unrelated sources and evaluating complex, multi-condition rule sets across disparate system components in real time. The alerts may control other systems/devices and/or alert personnel to various scenarios for which alerts have been formatted. The alert platform is adaptable across multiple industries, including but not limited to public safety, enterprise operations, critical infrastructure, and smart city environments.

Existing alerting systems often rely on rigid, single-state FSMs that lack the flexibility to effectively handle the complex and dynamic nature of modern security environments. Existing alerting solutions are limited to operating over indexed document data within a single query context. In the rapidly evolving landscape of security systems and Internet of Things (IoT) technologies, there exists a critical need for a unified and adaptive alerting engine capable of seamlessly integrating data from diverse sources such as physical security, IoT devices, and cyber-security systems.

The example embodiments provide for multiple FSMs that may be configured to feed each other as opposed to the single-state FSMs currently implemented. The example embodiments overcome this limitation through two purpose-built Domain-Specific Languages (DSLs). A first DSL enables structured querying over pipeline object data and a second DSL enables rule evaluation over platform entities and an integration-layer data via resource names. The resource names serve as a unified addressing scheme allowing the system to resolve and incorporate live variables from any registered component within the broader platform, pulling together data from otherwise separate systems at the moment a rule is evaluated.

The alert platform also permits rule conditions to reference and jointly evaluate data from multiple independent sources within a single rule definition. This enables compound conditional logic that spans positional telemetry, video analytics, integration state, and system health indicators simultaneously. A rule may, for instance, trigger an alert only when a tracked asset arrives at a designated location, an occupancy condition is met in a monitored region, a dependent device reports an active status, etc. where all these may be evaluated as a single atomic condition.

The alert platform further supports configurable re-alert behavior, where alerts may be suppressed, repeated, or escalated based on user-defined intervals and state persistence. Rule evaluation additionally adheres to platform-level scheduling constructs, allowing alert conditions to be scoped to defined operational windows.

The example embodiments allow for integration of multiple type of alerting technologies. The example embodiments provide a unified platform for integrating data from any physical security, IoT, software defined or proprietary system. By leveraging a software ontology framework, the example embodiments harmonize disparate data formats, protocols, and structures, facilitating seamless interoperability and data exchange across diverse security domains.

Specifically, a multi-FSM architecture enables the representation of complex security scenarios with multiple states and transitions. Each FSM encapsulates a unique security context, encompassing various states indicative of system conditions, threats, or anomalies. The FSMs are not static but adapt dynamically to evolving security conditions, leveraging real-time data inputs to trigger state transitions and drive appropriate alerting actions.

Unlike alerting mechanisms that trigger responses based on binary conditions (e.g., motion detected/not detected), the example embodiments support granular, multi-state alerting. Each FSM within the engine is configured with a set of states, each representing a distinct security posture or condition. This granularity allows for more precise detection and characterization of security events, enabling context-aware alerting actions tailored to the specific state of the system.

The FSM states are translatable into actionable intelligence. Rather than merely alerting users to security events, the example embodiments analyze the current state of each FSM in context with the broader security landscape and organizational policies. Based on this analysis, a range of response actions may be orchestrated, including automated incident remediation, notification escalation, resource allocation, and decision support, empowering users to proactively manage security threats.

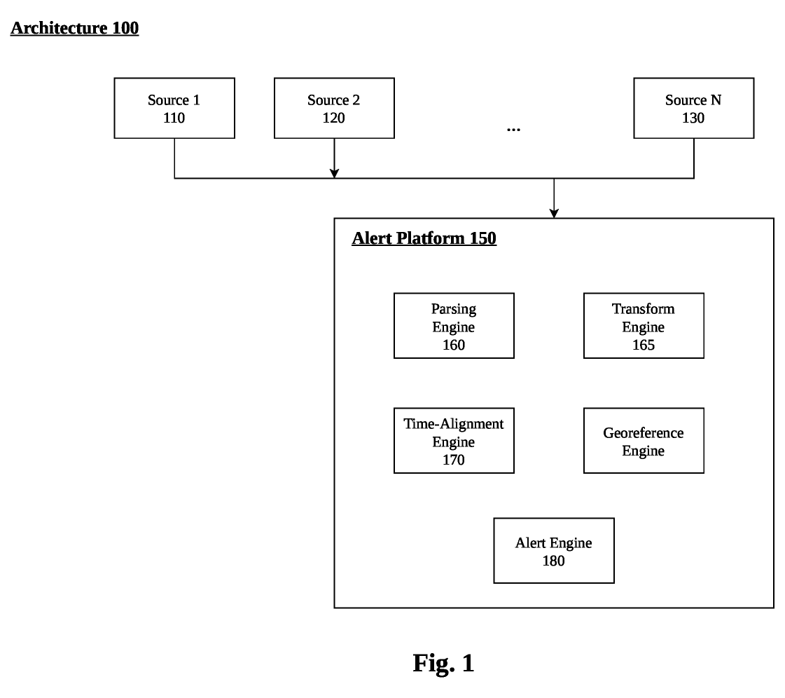

FIG. 1 shows an example architecture 100 according to various example embodiments. In FIG. 1, multiple sources systems 110-130 are shown. These multiple source systems 110-130 may generate data for input into the alert platform 150. The inputs generated by the source systems 110-130 may include, for example, structured data, semi-structured data, unstructured data, streaming data, geospatial data, sensor-derived data, image data, video data, audio data, text data, metadata, event-based data, etc. Supported inputs may include cameras, video management systems (VMS), panic buttons, sensors, application programming interfaces (APIs), data streams, and event-based systems. The data described above are only examples and other types of data may also be ingested by the alert platform 150. In general, the alert platform 150 may ingest any type of data and this data is heterogenous, e.g., the data ingested by the alert platform 150 may be unrelated data.

The alert platform 150 may include a series of input engines 160-175 that normalize the ingested data into a common data representation. In the example of FIG. 1, the input engines that operate on the input data includes a parsing engine 160, a transform engine 165, a time-alignment engine 170 and a georeferenced engine 175. Some examples of the operations performed by these engines are described in greater detail below. The input engines are only examples and there may be other types of input engines that normalize the input data based on the type of source system and/or input data that is ingested by the alert platform 150. In addition, there is no requirement as to the number or types of input engine that are used to process any input data. For example, some input data may be processed by each of the input engines 160-175. Other input data may be processed by only one of the input engines 160-175. The point of the operation of the input engines 160-175 is to normalize the input data so that it may be further processed by the alert platform 150.

Thus, after the input data is normalized, the input data may be processed by an alert engine 180 of the alert platform 150. The alert engine 150 may perform various operations such as cross-source searches, correlation, artificial intelligence (AI) analysis, alert generation, three-dimensional visualization, etc. In some example embodiments, the alert engine 180 may evaluate one or more source-derived signals and one or more AI-derived detections against a plurality of configurable trigger conditions. The trigger conditions may include logical combinations, sequential dependencies, temporal windows, spatial relationships, confidence thresholds, priority scores, data-source correlations, workflow state changes, etc. In response to one or more trigger conditions being satisfied, the alert engine 180 may execute one or more response actions, including generating an alert, assigning a severity level, notifying a recipient, initiating an automated workflow, transmitting data to an external system, or modifying a three-dimensional geospatial display.

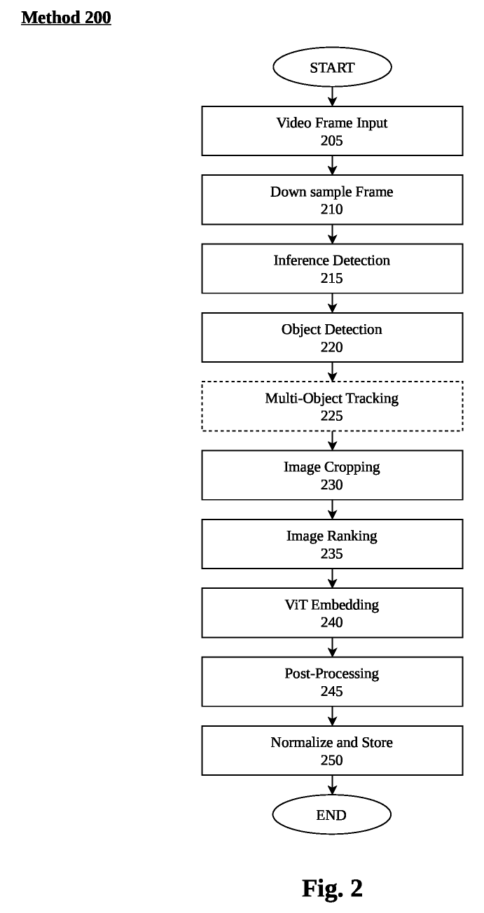

FIG. 2 shows an example method 200 for contrastive language image pre-training (CLIP) according to various example embodiments. As described above, the source systems 110-130 may be any type of inputs. In this example, it may be considered that the source system inputs video data into the alert platform 150. The alert platform 150 may include a base AI model that may then be trained on a custom dataset. For example, the base AI model may be any model that may be used to analyze video or detect objects within a vide stream. In some example embodiments, the base AI model may be a Primary Generalized Inference Engine (PGIE). However, this is not a requirement of the example embodiments. The base AI model may be further trained to detect specific types of objects within a video.

For example, if the video is a surveillance system and the alert platform 150 is related to stopping intruders, the base AI model may be further trained to identify humans within the video. In further detail, the alert platform 150 may be to prevent unauthorized persons (e.g., non-uniformed persons, non-military personnel, etc.) from entering a secure area. The base AI model may be further trained to distinguish one type of person (e.g., a uniformed military person) from another person (e.g., a civilian). In other examples, the alert platform 150 may be related to vehicle traffic and the base AI model may be further trained to identify vehicles within the video. In further detail, the base AI model may be trained to identify or distinguish specific types of vehicles, e.g., police cars, fire trucks, ambulances, etc. from other types of vehicles. These are only examples and the base AI model may be further trained based on the task (or alert) that the alert platform 150 is designed to monitor.

In 205, the source system (e.g., any of the source systems 110-130) may input raw video data (e.g., video frames) into the alert platform 150. Each video frame may include a timestamp of system time or upon input into the alert platform 150 a timestamp of system time may be assigned to each vide frame. In 210, the input frames may be downsampled for inference through the primary machine learning model (e.g., PGIE model).

In 215, each frame may be input into the base AI model for inference detection of an object within the frame. In 220, a primary object may be detected by the base AI model within the frame. As described above, the AI model may be trained to detect any type of object (e.g., vehicle, person, animal, etc.).

In some example embodiments, the primary object may be detected using optical flow methods. For example, motion may be detected in a scene and this motion may be interpolated to find a ‘bounding box’ of whatever is causing motion in the scene. Thus, there may be multiple manners of detecting the primary object in an image or frame.

In some example embodiments, the AI model may be trained to track multiple objects (e.g., the same types of objects or different types of objects) within the video input. If this is the case, in 225, the AI model may assign persistent identifications (IDs) for an object in the video frame. In this way, the object may be tracked across multiple frames and multiple objects may be tracked across multiple frames. In 230, the primary object may be cropped from the full size input frame, e.g., to produce a high resolution image of the primary object.

In 235, an image ranking algorithm may be used. The image ranking algorithm may use heuristics and confidence metrics to pick the ‘best’ image for inference among the multiple captured images for that object. The image ranking algorithm may consider one or more of the image size (e.g., crops from 230 that are larger may be considered to be better images), a PGIE detection confidence (e.g., the PGIE model may attach a confidence value to the object detection for any particular frame), occlusion detection (e.g., objects that are overlapped may have a lower degree of confidence because only a portion of the object may be in the video frame), edge distance (e.g., objects that are identified closer to the edge of the image may have a lower confidence). These are only some examples of the factors that may be considered when ranking images and other factors may also be considered.

In 240, the ranked images (e.g., a selection of the most highly ranked cropped high resolution images) may be passed through a vision transformer (ViT) model to generate an embedding vector. In some example embodiments, the embedding vector may be a 512-dimensional vector. However, other dimensions or types of embedding vectors may be used.

In 245, the generated embedding vector may be post processed such that it may be used for re-identification. The post processing may include, for example, mean centering where the per-camera Exponential Moving Average (EMA) mean embedding is subtracted to remove deployment and camera specific noise. In another example, superID re-association may be applied. For example, a buffer of nearby objects on the same camera within the same time period may be maintained. A cosine similarity may be applied between the input embedding and these other embeddings along with a position and time heuristic to re-associate objects. In a further example, domain projection may be applied to map the CLIP space to a domain-specific space. This may allow, for example, the implementation of separate vehicle/person re-identification models that are downstream of the primary CLIP model. Again, these are only some examples of post processing that may be applied and other types of post processing may also be applied.

In 250, the post processed embedding vector may be normalized and stored in a database for later searching through K nearest neighbor (K-NN) searching. When a search is performed, the example embodiments that include the CLIP model and the re-identification model may allow for search-time re-ranking. For example, during a search, a user may provide an indication (e.g., thumbs up/thumbs down) in the search. This may combine the text/image embedding k-NN query with a re-identification k-NN search between the signaled objects and the remainder of the search results to dynamically re-rank at search time. Thus, the method 200 shows how a base AI model may be trained to search for specific objects within images or video frames.

As described above, the alert platform 150 may receive input from multiple source systems 110-130. The training of the specific AI model for image searching on video/image inputs is only one example of AI models that may be applied to the input data. Other AI models may be trained and used for different types of inputs.

As described above, the alert platform 150 may receive inputs from various different source systems 110-130 including, for example, unstructured data, structured data, text data and metadata. The source system 110-130 may be an external system integrated with the alert platform 150. For example, the source system 110-130 may be deployed on an edge device in a customer environment. The alert platform 150 may transform the data into a common schema, e.g., fields in the schema that are text describing locations, may be geocoded into geospatial data, etc.

The example embodiments allow for various searches to be performed on the input data. The searching may be based on semantic similarity with text and/or images. A user may generate the search based on a prompt that may include, for example, a description of the target. A semantic search may then be used to find relevant matches, e.g., images with police cars, etc.

The search results may be displayed to the user. The example embodiments may also allow the user to refine the query by searching within the images. For example, a search result that has an image of an object that the user intended may be flagged with an indication, e.g., ‘thumbs-up’, check marks, etc. The example embodiments allow a user to formulate a search that combines both text prompts and image prompts in one aggregated search.

The alert platform 150 may create custom tags that are the result of an object matching a prompt with a threshold level of certainty. For example, the search may be formulated as two categories ‘fire truck’ and ‘police car’ and then set thresholds for whenever an image matches that prompt with the threshold level of certainty. In another example, an alert may be created from objects matching a prompt with a certain level of certainty. For example, an alert may be created for an object (e.g., red jeep). When an object matches that prompt is identified, an alert is triggered.

In some example embodiments, the alert platform 150 may also allow for semantic ignore lists to be created. For example, an object may be identified in an image using semantic similarity and a position in the camera may be used to permanently ignore the object. For example, if an object like a mannequin is detected as a person in a store, the mannequin may be added to an ignore list. To generate the ignore list, a user may identify an object they wish to ignore in the dashboard. A click box (e.g., ignore object) may be clicked to permanently ignore the object. The alert platform 150 may then save all embeddings for this object to a blacklist along with position in the frame and the camera ID. The incoming embeddings may be compared to the saved blacklist and if the similarity passes a first threshold, and the distance between the saved positions is below a second threshold, the image may be dropped.

The example embodiments may also support web Real Time Communications (WebRTC) using a media router to relay streams to reduce network load and support many simultaneous viewers. The media router service may either be hosted in the cloud to facilitate broadcast to global viewers, or at additional on-premise locations such as a command center.

Multiple alert platforms may be peered either permanently or temporarily to allow federation between different clusters. For example, this may allow for cross-organization searching, temporary or permanent sharing of cameras devices between organizations, sharing past recordings and/or collected data, etc.

To provide a federation example, two organizations (e.g., a school and a command center) may be federated to allow the command center to access cameras and search across the school’s collected data. The command center may send a peering request to the school with a duration of 3 months. This may appear under dashboard settings and may also be sent as an email to the dashboard administrators. The school reviews and accepts the peering request resulting in the school’s virtual network and the command center being connected. However, the command center may still not access any data. The command center may send a federation request specifying the scope and duration of the requested data access the school, e.g., appearing in dashboard settings and as an email. The school accepts the federation request and the command center can now access the requested data for the specified duration. Three months later, the peering expires and the school and command center’s networks are no longer connected. Federation requests may no longer be sent until the networks are peered again.

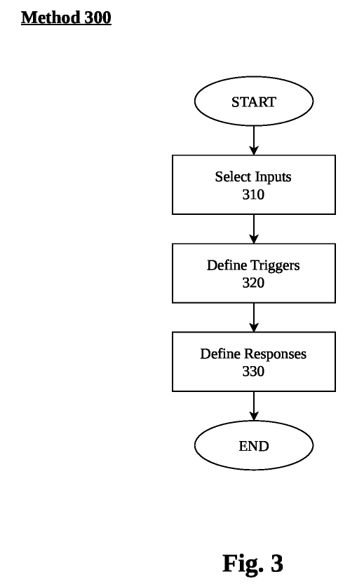

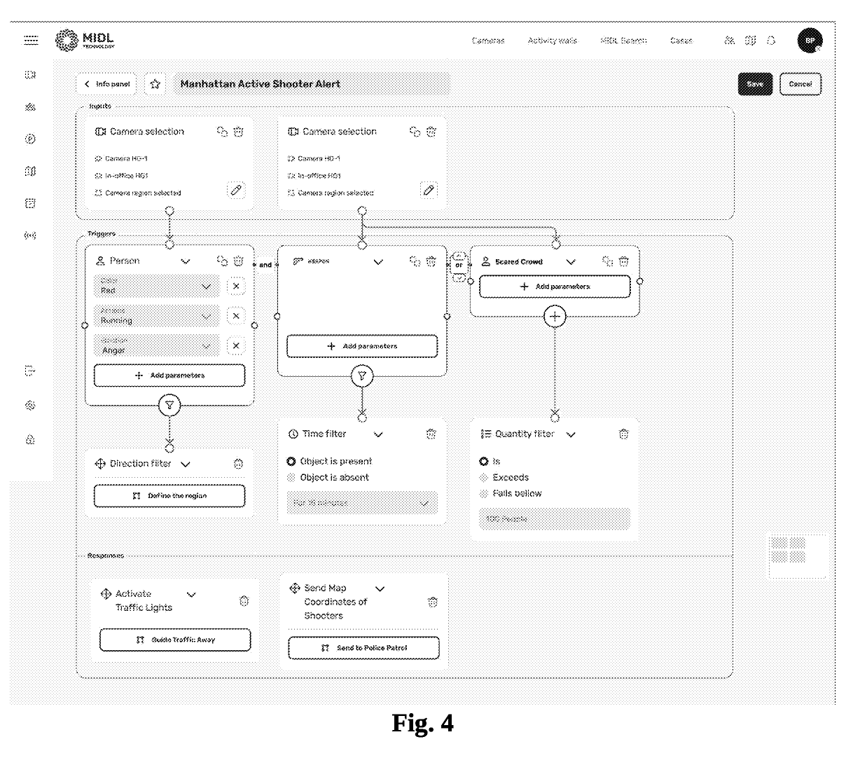

FIG. 3 shows an example method 300 for formatting alerts according to various example embodiments. The method 300 of FIG. 3 is described with reference to the example input screen of FIG. 4.

FIG. 4 shows an example graphic user interface (GUI) 400 for formatting alerts according to various example embodiments. The GUI 400 is used to format an alert for an active shooter scenario. However, this is only an example and any other type of alert may be formatted in a similar manner as is described with reference to the active shooter scenario. The GUI 400 may be displayed by the alert platform 150. The GUI 400 may have a series of drop down menus, selection bars, operator selections (e.g., AND, OR, NOR, etc.), check boxes, etc. that may be used to select various information as was described above and additional examples as described below.

In 310, the user formatting the alert may select the inputs that are to be used for the alert. In the example of FIG. 4, the user has selected various cameras as inputs. Again, as described extensively above, there may be other types of inputs that may also be selected. For example, if the alert is related to a fire, smoke detectors and/or fire alarms may be selected as inputs. In other examples, the fire alarms may also be selected as an input for the active shooter scenario, e.g., it may be that when an active shooter scenario occurs, people tend to pull fire alarms as a manner of alerting others to the danger and therefore the fire alarm input may also be a valuable input in an active shooter scenario.

In 320, the triggers for the alert may be defined. In the example of FIG. 4, the triggers may be, for example, the identification of a person that is running and is expressing an emotion of anger. The examples above described manners of identifying a person and/or motion in a video. In addition, AI models may also be used to identify emotions of the person, e.g., based facial expressions, body movements, etc. In the example of FIG. 4, the trigger may also include the identification of a gun. Again, the primary object identified in a video frame may be any type of object (e.g., person, gun, car, etc.). Furthermore, the identification of a gun may not be a direct identification of a gun but may be an identification of an indicia of a gun. For example, AI may be trained to determine if a bulge in a coat or pants of a person is an indication of a gun. So in the example of FIG. 4, one trigger may be the direct indication of a gun (e.g., identified in video frame) but another trigger (not shown) may be an indicia of a gun. These two triggers may have different associated confidence values. For example, if the AI model is 50 % confident it has identified a gun in an image, that may be sufficient to trigger the alert. However, if the trigger is the indicia (e.g., bulge in clothing), the user may set a much higher confidence value to trigger the alert (e.g., 90 %, 95 %, etc.).

In the example of FIG. 4, the first trigger (person) is coupled in an AND construction with the second trigger (gun). FIG. 4 also shows an alternate trigger (scared crowd) that is coupled in an AND construction with the first trigger (person) and an OR construction with the second trigger (gun). FIG. 4 also shows that various parameters may be set for the triggers including presence/absence, quantities, confidence values, physical dimensions, etc. Again, the triggers may be any trigger that is indicative of the particular scenario for which the user is defining an alert.

In 330, the user may define responses to the triggers being activated. In some scenarios, the activation of the triggers may cause control over other devices. For example, in FIG. 4, traffic lights may be controlled to allow first responders to make their way to the scene more quickly. However, other types of device control may also be exerted, e.g., safety doors may be closed/locked, fire alarms may be triggered, sprinkler systems may be triggered, automated announcements may be triggered, etc. In other scenarios, the alert may be an alert message, e.g., to police, to fire personnel, to a command center, etc. In further scenarios, the alert message may include additional information such as details of the detected scenario, maps/blueprints of a building where the alert has been generated, maps/directions to the location of the alert, etc.

At the completion of the method 300, the alert has been formatted and the alert platform 150 may monitor the inputs and the triggers to determine if a response is warranted. The GUI 400 also allows a user to reformat any of the alerts, e.g., by adding new inputs or new triggers, changing parameters for the triggers, changing responses to the alert, etc.

As stated above, the example method 300 is described with reference to the GUI 400 that may provide a manner for a user to generate structured searches for the formatted alert. The example embodiments are not limited to formatting alerts using a structure search. In other example embodiments, a natural language search may be used to format the alert. For example, a user may enter a natural language input of “set an alert that monitors for x y and z from these sources and then takes these actions.” Thus, instead of a structured input, the alert platform 150 may parse the natural language input and format an alert including, for example, inputs, triggers, responses, based on the natural language input.

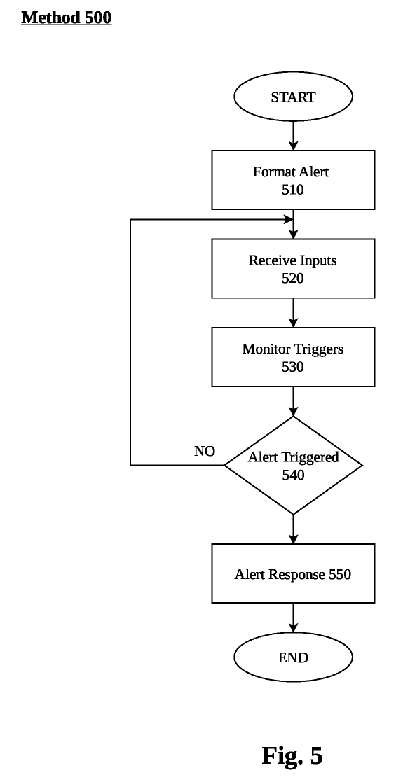

FIG. 5 shows an example method 500 for generating alerts according to various example embodiments. The method 500 may be performed by the alert platform 150.

In 510, an alert may be formatted by a user. The example associated with FIGS. 3 and 4 described above provide various examples of formatting an alert.

In 520, the alert platform 150 receives inputs from the various source systems 110-130. As data is received from the various source systems 110-130, the data is automatically standardized into a unified format, enabling cross-system interoperability and centralized monitoring.

In 530, the alert platform 150 may monitor the various triggers. The alert platform 150 is designed to support the application of artificial intelligence (AI)/machine learning (ML) models on top of the normalized data, enabling advanced analytics, pattern detection, anomaly recognition, automated decision support, etc. As described above, natural language may be used to format a search. Natural language may also be used to trigger a search related to the alert based on a FSM or context. For example, in a particular FSM or context, an input may be a natural language input of “I have a fire.” The alert platform 150 may use this natural language input to initiate a search related to fire trucks or other types of fire equipment related to the “fire” related alert.

In 540, the alert platform 150 determines whether any alerts have been triggered based on the formatted alerts implemented by the alert platform 150. If no alert is currently triggered, the method 500 loops back and continues to receive inputs and monitors the triggers. If an alert has been triggered, the alert platform 150 generates the alert response in 550. Some example alert responses were described above.

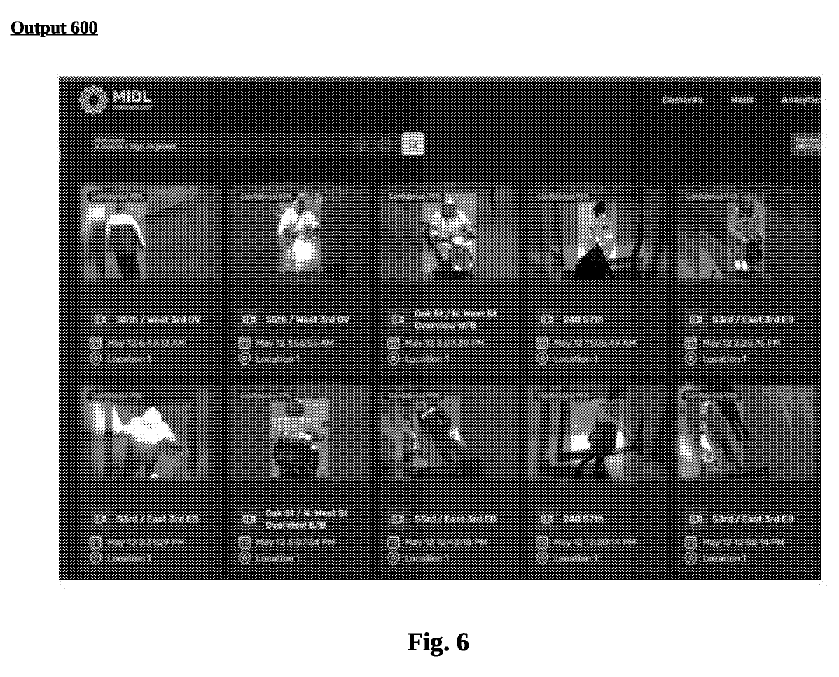

FIG. 6 shows an example of an image output 600 for an object search according to various example embodiments. As described above, during model training or during operation, the alert platform 150 may output images related to an object search. FIG. 6 shows an example of a grid output 600 of images related to a search for an object (e.g., man in high visibility jacket). The output 600 shows each of the images and various data that may be associated with the images, such as, a confidence value, a geolocation, an input source (e.g., camera ID), a timestamp, etc.

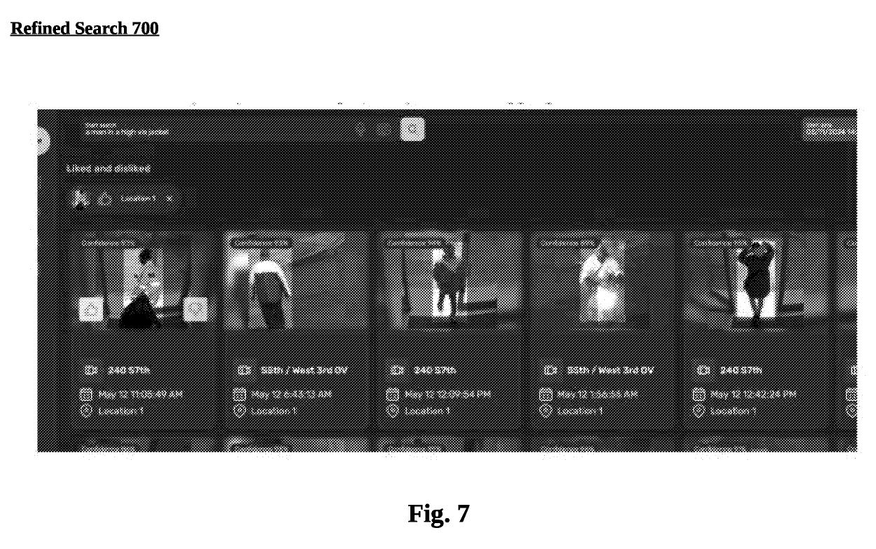

FIG. 7 shows an example of refining an image search 700 according to various example embodiments. As described above, a user may refine an image search by selecting or deselecting various images in the search results. The example of FIG. 7 shows the same search results as the output 600 of FIG. 6, except that only the top row of the grid is shown. As can be seen, a user may refine the search by selecting an image (e.g., the leftmost image has been selected based on the “thumbs up” indication. The user may also refine the search by deselecting an image (e.g., the second image from the left image has been deselected based on the “thumbs down” indication.

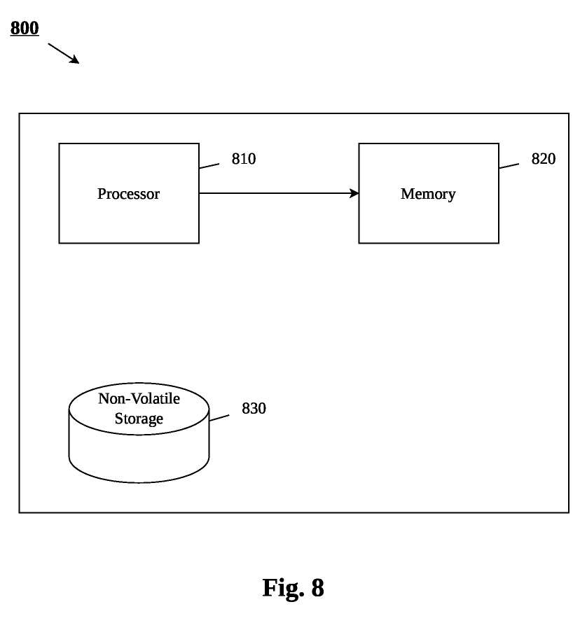

FIG. 8 shows an illustrative implementation of a computer system 800 that may be used in connection with any of the embodiments of the disclosure provided herein, e.g., the alert platform 150. The computer system 800 may include one or more processors 810 and one or more articles of manufacture that comprise non-transitory computer-readable storage media (e.g., memory 820 and one or more non-volatile storage media 830). The processor 810 may control writing data to and reading data from the memory 820 and the non-volatile storage device 830 in any suitable manner. To perform any of the functionality described herein, the processor 810 may execute one or more processor-executable instructions stored in one or more non-transitory computer-readable storage media (e.g., the memory 820), which may serve as non-transitory computer-readable storage media storing processor-executable instructions for execution by the processor 810.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Linux OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

What is claimed:

1. A system, comprising:
a processor coupled to memory, the processor configured to:
receive multiple inputs associated with an alert, wherein a first one of the multiple inputs has a different format from a second one of the multiple inputs;
normalize the first one and the second one of the multiple inputs into a common data representation;
determine, based on the multiple inputs, whether a trigger condition for the alert has been satisfied; and
when the trigger condition has been satisfied, generate an alert response.

2. The system of claim 1, wherein the multiple inputs comprise one or more of structured data, semi-structured data, unstructured data, streaming data, geospatial data, sensor-derived data, image data, video data, audio data, text data, metadata, or event-based data.

3. The system of claim 1, wherein the alert comprises an identification of the multiple inputs associated with the alert, triggers associated with the trigger conditions for the alert, parameters for the triggers and the alert response for the alert.

4. The system of claim 3, wherein the processor is further configured to:
process, based on input received by a graphical user interface (GUI), an alert format for the alert comprising one or more of the identification of the multiple inputs associated with the alert, the triggers associated with the trigger conditions for the alert, the parameters for the triggers and the alert response for the alert.

5. The system of claim 1, wherein the parameters for the triggers comprise one or more o of a confidence value, a geolocation, an input source identification or a timestamp.

6. The system of claim 1, wherein the processor determines whether the trigger condition for the alert has been satisfied based on one or more of inputting the normalized data into an artificial intelligence (AI)/machine learning (ML) model, inputting the normalized data into an analytic engine, inputting the normalized data into a pattern detection engine, or inputting the normalized data into an anomaly recognition engine.

7. The system of claim 6, wherein tat least one of the multiple inputs comprise image information and the AI/ML model is trained to recognize a primary object in one or more images.

8. The system of claim 1, wherein the alert is related to one of public safety, enterprise operations, critical infrastructure, or smart city environments.

9. A method, comprising:
receiving multiple inputs associated with an alert, wherein a first one of the multiple inputs has a different format from a second one of the multiple inputs;
normalizing the first one and the second one of the multiple inputs into a common data representation;
determining, based on the multiple inputs, whether a trigger condition for the alert has been satisfied; and
when the trigger condition has been satisfied, generating an alert response.

10. The method of claim 9, wherein the multiple inputs comprise one or more of structured data, semi-structured data, unstructured data, streaming data, geospatial data, sensor-derived data, image data, video data, audio data, text data, metadata, or event-based data.

11. The method of claim 9, wherein the alert comprises an identification of the multiple inputs associated with the alert, triggers associated with the trigger conditions for the alert, parameters for the triggers and the alert response for the alert.

12. The method of claim 11, further comprising:
processing, based on input received by a graphical user interface (GUI), an alert format for the alert comprising one or more of the identification of the multiple inputs associated with the alert, the triggers associated with the trigger conditions for the alert, the parameters for the triggers and the alert response for the alert.

13. The method of claim 9, wherein the parameters for the triggers comprise one or more o of a confidence value, a geolocation, an input source identification or a timestamp.

14. The method of claim 9, wherein the processor determines whether the trigger condition for the alert has been satisfied based on one or more of inputting the normalized data into an artificial intelligence (AI)/machine learning (ML) model, inputting the normalized data into an analytic engine, inputting the normalized data into a pattern detection engine, or inputting the normalized data into an anomaly recognition engine.

15. The method of claim 14, wherein tat least one of the multiple inputs comprise image information and the AI/ML model is trained to recognize a primary object in one or more images.

16. The method of claim 9, wherein the alert is related to one of public safety, enterprise operations, critical infrastructure, or smart city environments.
